(19) United States
(12) Patent Application Publication
(10) Pub. No.: US 2002/0138411 A1
(43) Pub. Date: Sep. 26, 2002

(54) On-line financing application services including financing application completion and processing

(76) Inventors: Clifford John Monlux, Seattle, WA (US); James Patrick Brady, Bellevue, WA (US); Brent Antoine Picasso, Edmonds, WA (US)

Correspondence Address: COLUMBIA IP LAW GROUP, PC, 10260 SW GREENBURG ROAD, SUITE 820, PORTLAND, OR, 97223, US

(21) Appl. No.: 09/815,073

(22) Filed: Mar. 22, 2001

(51) Int. Cl. G06F 17/60

(52) U.S. Cl. 705/38

(57) ABSTRACT

An on-line financing application service is equipped to electronically facilitate a vendor/broker or a client of the vendor/broker to complete different sections of a financing application under a financing program offering of a funding source. The service is also equipped to automatically select a rate structure in for the completed financing application in accordance with a pre-defined rate structure selection process. Further, the service is equipped to facilitate submission of the completed financing application for consideration, and the service automatically process the submitted financing application in accordance with a pre-defined financing application approval/disposition process, approving, rejecting, or referring the application to a different rate structure for quote, or consideration under a different financing program offering of the same or different funding sources.

### BACKGROUND OF THE INVENTION

1. Field of the Invention

The present invention relates to the field of electronic data/information processing. More specifically, the present invention relates to electronic data/information processing methods and apparatuses for hosting on-line financing application services.

2. Background Information

With advances in integrated circuit, microprocessor, networking and communication technologies, increasing number of devices, in particular, digital computing devices, are being networked together. Devices are often first coupled to a local area network, such as an Ethernet based office/home network. In turn the local area networks are interconnected together through wide area networks, such as ATM networks, Frame Relays, and the like. Of particular notoriety is the TCP/IP based global inter-networks, the Internet.

As a result this trend of increased connectivity, increasing number of applications that are network dependent are being deployed. Examples of these network dependent applications include but are not limited to, email, net-based telephony, world wide web and various types of e-commerce. Further, increasing number of software applications that were traditionally licensed or distributed through discrete distribution medium, such as diskettes, CDROMs and the like, are being distributed online or offered as web based applications, through private intranets or public networks like the Internet.

In like manner, some prior art financing applications are being converted into on-line or web based applications. However, the offerings to-date have been lacking in functionalities, e.g. in the areas of program offering creation, automatic rate selection, and automatic approval/disposition processing (i.e. rejection, referral and so forth). In particular, there is no known offering that provides comprehensive association between the funding sources/providers, their financing program offerings and brokers/vendors.

Thus, a more comprehensive improved financing application service is desired.

### SUMMARY OF THE INVENTION

An on-line financing application service is equipped to electronically facilitate a vendor/broker or a client of the vendor/broker to complete different sections of a financing application under a financing program offering of a funding source. The service is also equipped to automatically select a rate structure for the completed financing application in accordance with a pre-defined rate structure selection process. Further, the service is equipped to facilitate submission of the completed financing application for consideration, and the service automatically processes the submitted financing application in accordance with a pre-defined financing application approval/disposition process, approving, rejecting, or referring the application to a different rate structure for quote, or consideration under a different financing program offering of the same or different funding sources.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an overview of the present invention, including the relationships between the various relevant entities, including the application service provider of the present invention, funding sources/providers, brokers/vendors, and their clients, in accordance with one embodiment;

FIG. 2 illustrates a method of the present invention for associating funding sources/providers, financing program offerings and vendors/brokers, in accordance with one embodiment;

FIG. 3 illustrates a component view of the financing application services of the present invention, in accordance with one embodiment;

FIG. 4 illustrates an end user interface for facilitating association of funding sources/providers, financing program offerings and broker/vendors, in accordance with one embodiment;

FIG. 5 illustrates a data structure suitable for use to practice the funding source/provider, financing program offerings and broker/vendor association aspect of the present invention, in accordance with one embodiment;

FIG. 6 illustrates the relevant operational flow of the administration tool of FIG. 3 associated with the funding source/provider, financing program offerings, and broker/vendor association aspect of the present invention, in accordance with one embodiment;

FIG. 7 illustrates the master application template of the present invention in further detail, in accordance with one embodiment;

FIG. 8 illustrates the method of the present invention for creating organizational and financing program offering application templates, in accordance with one embodiment;

FIGS. 9a-9b illustrate an end user interface of the financing program creation tool of FIG. 3 for creating organizational/program application templates, in accordance with one embodiment;

FIGS. 10a-10b illustrate the relevant operational flows of the financing program creation tool of FIG. 3 associated with creating organization/program application templates, in accordance with one embodiment;

FIG. 11 illustrates the method of the present invention for creating a financing program, in accordance with one embodiment;

FIG. 12 illustrates an end user interface for facilitating creation of a rate structure for a financing program, in accordance with one embodiment;

FIG. 13 illustrates the relevant operational flow of the financing program creation tool of FIG. 3 associating with facilitating creation of a rate structure, in accordance with one embodiment;

FIGS. 14a-14d illustrate an end user interface for facilitating a funding source/provider in defining a rate structure selection workflow or a financing application process workflow for a financing program, in accordance with one embodiment;

FIG. 15 illustrates a resultant rate structure selection or financing application process workflow specification of the present invention, in accordance with one embodiment;

FIG. 16 illustrates the relevant operational flow of the program creation tool of FIG. 3 associated with facilitating creation of a rate structure selection workflow or a financing application processing workflow, in accordance with one embodiment;

FIGS. 17a-17b illustrate the relevant operational flow of the financing application module of FIG. 3 associated with automatic selection of a rate structure and automatic processing of a financing application, in accordance with one embodiment;

FIG. 18 illustrates an end user interface of the financing application module of FIG. 3 for facilitating on-line preparation and submission of a financing application for one of the financing program offerings, in accordance with one embodiment;

FIG. 19 illustrates the relevant operational flows of the financing application module of FIG. 3 associated with facilitation of on-line preparation and submission of a financing application, in accordance with one embodiment;

FIG. 20 illustrates a computing environment suitable for practicing the financing application service provider aspect of the present invention, in accordance with one embodiment; and

FIG. 21 illustrates a computer system suitable for use as one of the server of FIG. 20 to practice the present invention, in accordance with one embodiment.

### DETAILED DESCRIPTION OF THE INVENTION

In the following description, various aspects of the present invention will be described. However, it will be apparent to those skilled in the art that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

Parts of the description will be presented using terms such as funding sources, brokers/vendors, clients, IDs, end-user interfaces, processes, and so forth, commonly employed by those skilled in the art to convey the substance of their work to others skilled in the art. Parts of the description will be presented in terms of operations performed by a computer system, using terms such as creating, authorizing, and so forth. As well understood by those skilled in the art, the data quantities and operations take the form of electrical, magnetic, or optical signals capable of being stored, transferred, combined, and otherwise manipulated through mechanical and electrical components of a digital system; and the term digital system include general purpose as well as special purpose data processing machines, systems, and the like, that are standalone, adjunct or embedded.

Various operations will be described as multiple discrete steps performed in turn in a manner that is most helpful in understanding the present invention, however, the order of description should not be construed as to imply that these operations are necessarily order dependent, in particular, the order the steps are presented. Furthermore, the phrase “in one embodiment” will be used repeatedly, however the phrase does not necessarily refer to the same embodiment, although it may.

### Overview

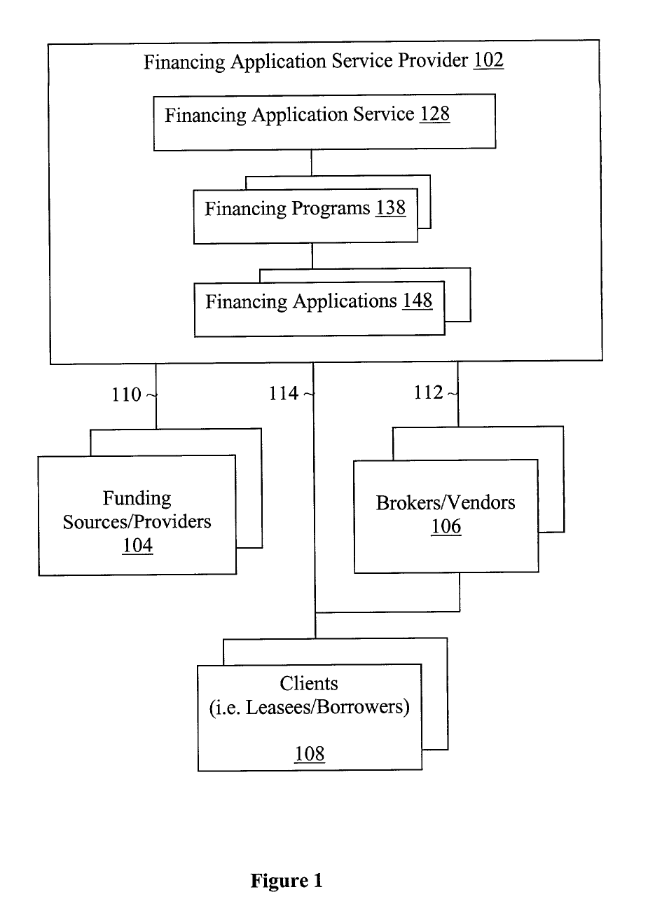

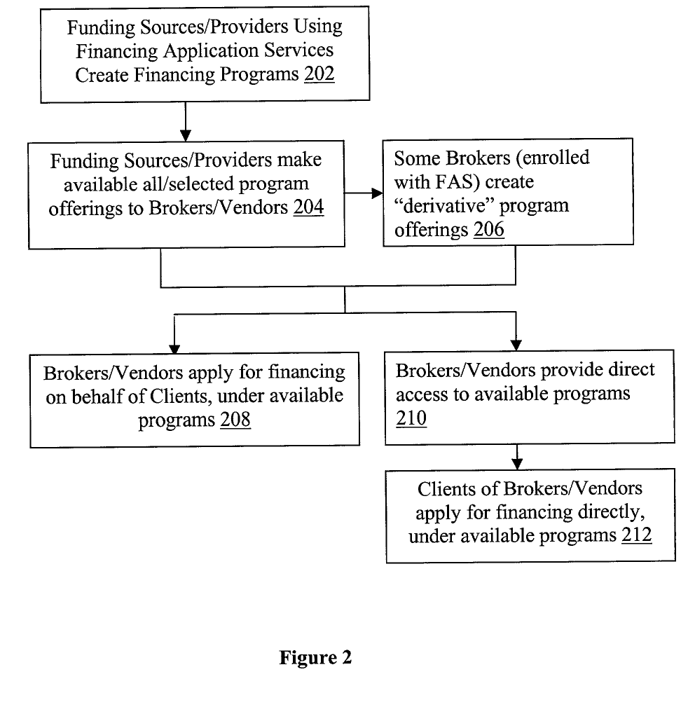

Referring now to FIGS. 1-2, wherein two block diagrams illustrating an overview of the present invention, including the relationships between the various relevant entities, i.e. the application service provider, funding sources/providers, brokers/vendors, their clients and so forth, in accordance with one embodiment, are shown. As illustrated, financing application service provider 102 of the present invention hosts on line financing application service (FAS) 128. As will be described in more detail below, licensed funding sources/providers 104 enrolled with FAS provider 128 as subscriber, would electronically access on line FAS 128 and create a number of electronically accessible financing programs (also referred to as financing program offerings) 138 (block 202). Funding sources/providers 104 further electronically make available, i.e. authorize, selected ones of brokers/vendors 106 to selected ones of funding sources/providers' electronically accessible financing program offerings (block 204). In some embodiments, some brokers 106 may also enroll with FAS provider 102 as subscribers, and create derivative financing program offerings 138 based on selected ones of their authorized financing program offerings 138 of the same/different funding sources/providers 102 (block 246).

Thereafter, broker/vendors 106 would either access on line FAS 128 and electronically complete financing applications 148 under the authorized electronically accessible financing program offerings 138 to apply for financing or on behalf of their clients (block 208), or electronically facilitate access to FAS 128 to their clients 108 (e.g. branding) to electronically complete financing applications 148 under the authorized electronically accessible financing program offerings 138 (blocks 210 and 212). In various embodiments, it is contemplated that for the former scenario, a broker/vendor would complete a “preliminary” application (which is a subset of a “full” application), and present to the client as a quote (for the client approval), prior to submitting the “full” application (presumably completed in cooperation with the client to obtain the necessary client information).

As will be described in more detail below, among the novel features offered by on line FAS 128 of the present invention are customized financing program offering creation, automatic rate selection, and automatic approval/disposition processing of a completed electronic application 148. Further, the disposition of an application 148 may include electronically referring the application for consideration under another rate sheet for quoting, or another electronically accessible program offering 138 of the same or a different funding source/provider 104 (or brokers 106). The referral may be made in accordance with a number of application dependent decision criteria, including but are not limited to the business profile and credit information of an applicant.

Accordingly, funding sources/providers 104, more specifically, their electronically accessible financing program offerings 148, brokers/vendors 106, and their clients 108 may be easily interrelated to each other, allowing funding sources/providers 104 to offer multiple electronically accessible financing programs, selectively authorizing for “representation” by different brokers/vendors 106, selective creation of derivative financing programs by brokers/vendors 106, on-line application completion and submission, and automatically approving or otherwise disposing financing applications by brokers/vendors 106 or clients 108 of vendor/brokers 106.

As illustrated, FAS provider 102, funding sources/providers 104, brokers/vendors 106 and clients 108, more specifically, their equipments, are communicatively coupled to one other, 110-114. Communication links 110-114 may be any one of a number of private or public networking links known in the art, including but are not limited to the Internet.

Accordingly, any one of a number of adequately equipped computing devices known in the art, including but are not limited to communication/networking enabled desktop computers, notebook computers or palm sized personal digital assistants (PDA), available from vendors such as Apple Computer of Cupertino, Calif. and Hewlett Packard of Palo Alto, Calif., may be employed by funding sources/providers 104, brokers/vendors 106 and clients 108 to practice the present invention. Similarly, any one of a number of adequately equipped server devices (and complementary peripherals) known in the art, including but are not limited to communication/networking enabled servers available from vendors such as Sun Microsystems of Menlo Park, Calif. and IBM of Armonk, N.Y., may be employed by FAS provider 102 to practice the present invention.

Thus, the hardware equipment and the system software employed thereon, employed by FAS provider 102, funding sources/providers 104, brokers/vendors 106 and clients 108 will not be further described. FAS 128 and its various relevant components, including the methods practiced, will be described in turn in the description to follow.

Further, it is readily apparent from the overview description thus far, the present invention relates to on-line financing application services, where the creation and customization of financing program offerings 138, the association of funding sources/providers 104, financing program offerings 138 and brokers/vendors 106, the completion and processing of financing applications 148 are all performed electronically, employing electronic data/information processing equipments. Therefore, for ease of understanding, terms such as “on line” and “electronically” will no longer be repeated over and over again in the description to follow to particularize the various “documents” referred to as being in electronic form, and operations performed in association therewith are electronically performed. In general, unless it is explicitly stated or the plain meaning in view of the context requires alternative reading, various “documents” and operations referred to in the description to follow should be read in default as being in electronic form and performed electronically.

### Components

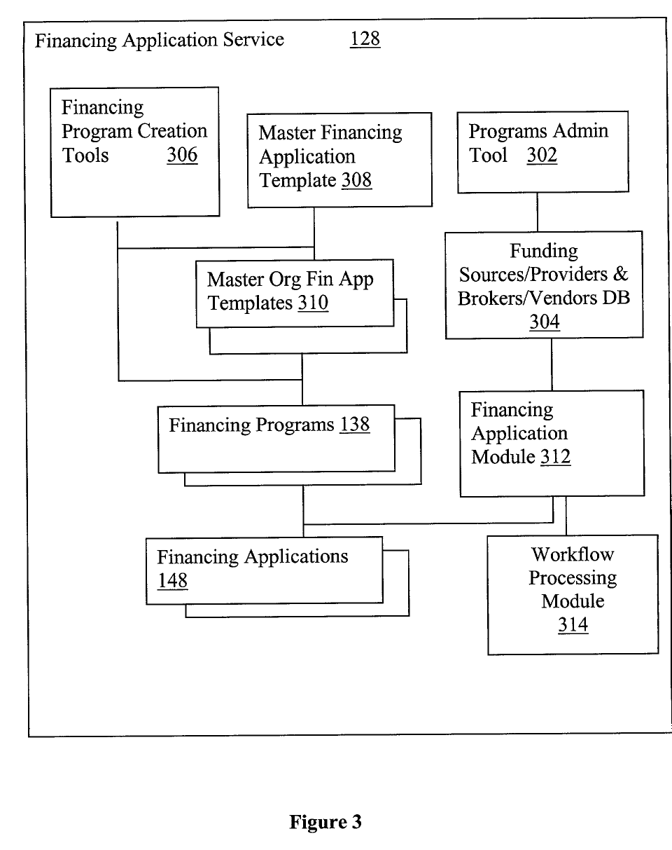

Referring now to FIG. 3, wherein a component view of FAS 128, including various associated elements, in accordance with one embodiment, is shown. As illustrated, FAS 128 includes financing program administration tool 302, financing program creation tools 306, financing application module 312 and its associated workflow processing module 314. Further, FAS 128 includes funding sources/providers and brokers/vendors database 304 and master financing application template 308. Financing programs administration tool 302 is provided to facilitate the earlier described financing program authorizations. For the illustrated embodiment, database 304 is employed to store the resulting association data.

Financing program creation tools 306 is provided to facilitate the earlier described financing program offering creations. For the illustrated embodiment, master financing application template 308 is employed to facilitate the individual funding sources/providers 104 in creating their respective organizational financing application templates 310, from which the various financing programs 138 are created. As will be described in more detail below, the creation of a financing program offering 138 includes in particular, the selection of required sections and data fields of a financing application, definition of rate structures and the decision process for selecting a rate structure, as well as definition of the decision process for approving or otherwise disposing a financing application. As described earlier, in preferred embodiments, disposition of a financing application preferably includes referral for consideration under another rate structure (for quote), or another financing program offering of the same or a different funding source/provider 104 or brokers 106. In various embodiments, rate structures may be shared across financing program offerings 138, accordingly definition of rate structures is “optional” during the creation of a financing program offering 138 (as long as existing ones are “available” for employment in the definition of the rate structure selection process).

Financing application module 312 is provided to facilitate the earlier described completion of various financing applications 148 under the various financing program offerings 138. For the illustrated embodiment, completion of a financing application for presentation by a broker/vendor 106 to a client 108 as a quote, or processing of a financing application 148 directly submitted by a client 108 includes automatic selection of a rate structure (by executing the definedrate structure selection process). Likewise, processing of a financing application 148 (regardless whether it is submitted by a broker/vendor 106, on behalf of a client 108 or by a client 108 directly) includes automatic approval or disapproval disposition (by executing the defined approval/disposition process). Workflow processing module 314 is provided to execute these decision processes (also referred to as workflows). As will be described in more details below, in one embodiment, these decision (workflow) processes are expressed employing XML like statements. Executable expressions are automatically generated in accordance with the various XML like statements, and in turn executed.

### Entity Association

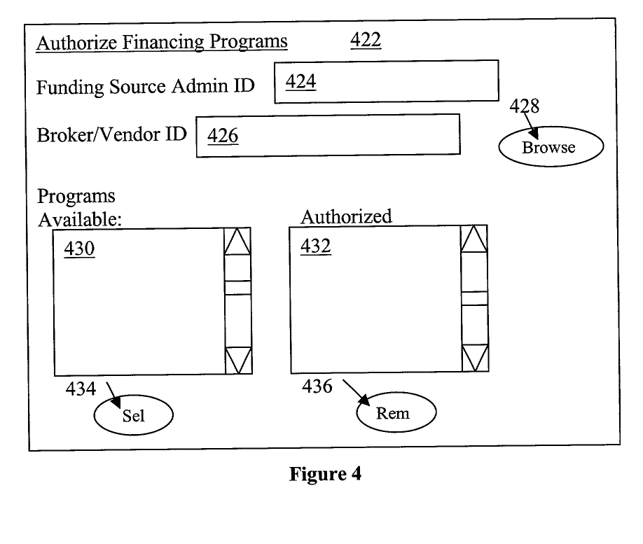

Referring now to FIG. 4, wherein a simplified view of an end user interface of programs administration tool 302, in accordance with one embodiment, is shown. As illustrated, the end user interface includes pane 422 for a funding source/provider to authorize brokers/vendors to work with selected ones its financing program offerings.

For the illustrated embodiment, pane 422 includes fields 424 and 426 for displaying an identifier of an authorizing funding source/provider and an identifier of the enrolled/registered broker/vendor being authorized, respectively. Pane 422 also includes “browse” button 428 for browsing and selecting an enrolled/registered broker/vendor to authorize. Further, pane 422 includes display areas 430 and 432 for displaying a list of the funding source/provider's created financing program offerings available for authorization, and for displaying the authorized financing program offerings, respectively. Pane 422 also includes “buttons” 434 and 436 for the broker/vendor to select (i.e. authorize) a highlighted financing program offering in the displayed available list, and to remove a highlighted financing program offering in the displayed authorized list, respectively.

As those skilled in the art would appreciate, pane 422 is simplified to illustrate the most relevant features for ease of understanding. In actual implementations, other graphical user interface features may be added.

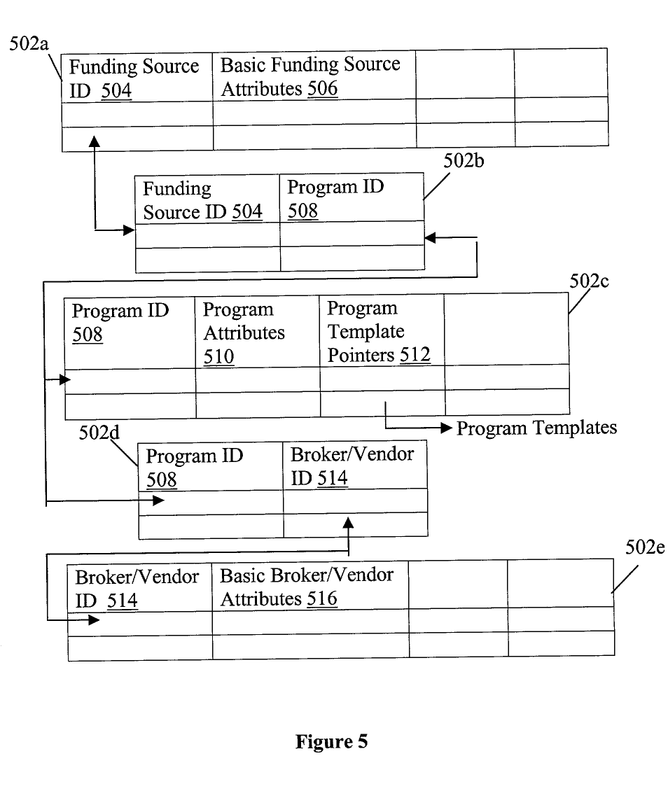

FIG. 5 illustrates a data organization suitable for use to store the various relevant data for practicing the present invention, in accordance with one embodiment. As illustrated, data organization 500 includes table 502a for storing the basic and other information about the funding sources/providers. Table 502a includes a number of record rows, one for each funding source/provider. Each record row includes at least column 504 for storing the funding source/provider identifier, and columns 506 for storing a number of attributes of the funding source/provider. These attributes may include e.g. the name of the funding source/provider, its address, phone number, and so forth.

Data organization 500 also includes table 502b for storing cross references cross referencing funding sources/providers to their financing program offerings. As illustrated, table 502b includes a number of record rows, one for each financing program offering of the funding sources/providers. Each record row includes at least column 504 for storing the funding source/provider identifier, and column 508 for storing an identifier of one of the funding source/provider's financing program offering.

Table 502c of data organization 500 is employed to store the basic and other information about the financing program offerings of the various funding sources/providers. Table 502c includes a number of record rows, one for each financing program offering. Each record row includes at least column 508 for storing the financing program offering identifier, columns 510 for storing a number of attributes of the financing program offering, and columns 512 for storing a pointer to the storage location of the program offering application template (for use by a vendor/broker or its client to complete a financing application). The financing program offering attributes may include e.g. the name of the financing program offering, and other related information.

Table 502d of data organization 500 is employed to store cross references cross referencing financing program offerings to the authorized brokers/vendors. As illustrated, table 502d includes a number of record rows, one for each financing program offering of the funding sources/providers. Each record row includes at least column 514 for storing the financing program offering's identifier, and column 512 for storing an identifier of one of the authorized brokers/vendors.

Table 502e of data organization 500 is employed to the basic and other information about the brokers/vendors. Table 502c includes a number of record rows, one for each broker/vendor. Each record row includes at least column 514 for storing the broker/vendor identifier, and columns 516 for storing a number of attributes of the broker/vendor. The broker/vendor attributes may include e.g. the name of the broker/vendor, its address, phone number and so forth.

In alternate embodiments, these data may be organized differently. Further, different data structures may be employed to store the data.

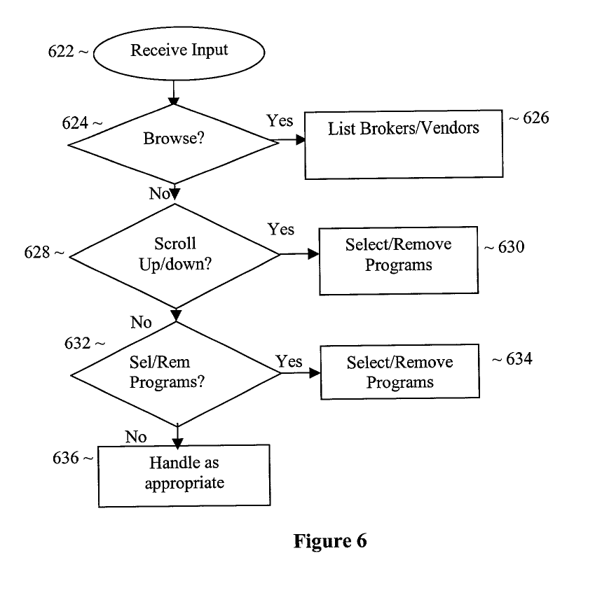

FIG. 6 illustrates the relevant operational flow of financing program (FP) administration tool 302 in support of the end user interface of FIG. 4, in accordance with one embodiment. More specifically, FIG. 6 illustrates the relevant operational flow for facilitating a funding source/provider in authorizing his/her financing program offerings.

As illustrated in FIG. 6, for the embodiment, upon receipt of an event notification associated with the financing program offering authorization interface of FIG. 4 (hereinafter, simply “request”), block 622, FP administration tool 302 determines if the request is associated with the user having selected the “browse” button of pane 422 of FIG. 4, block 624. If so, FP administration tool 302 displays a list of known brokers/vendors for selection by the funding source/provider, block 626. If not, FP administration tool 302 determines if the request is associated with the user interacting with the scroll bar of either the list displayed in display field 430 or the list displayed in display field 432, block 628. If so, FP administration tool 302 effectuates scrolling of the displayed list accordingly, block 630. If not, FP administration tool 302 continues at block 632.

At block 632, FP administration tool 302 determines if the request is associated with the selection of the “sel” or “rem” button 434/436. If so, FP administration tool 302 selects the newly designated financing program or removes a selected financing program accordingly, block 634. If not, FP administration tool 302 continues at block 636, where the input is assumed to be a conventional input, which is handled accordingly in a conventional application dependent manner, block 636.

### Organization Financing Program Template Creation

As earlier described, for the illustrated embodiment, financing program offering creation involves first the creation of an organizational financing application template 310, using the master financing application template 308 of FAS 128. Thereafter, financing program offerings 138 of the various funding sources/providers 104 are created using the respective organizational financing application templates 310.

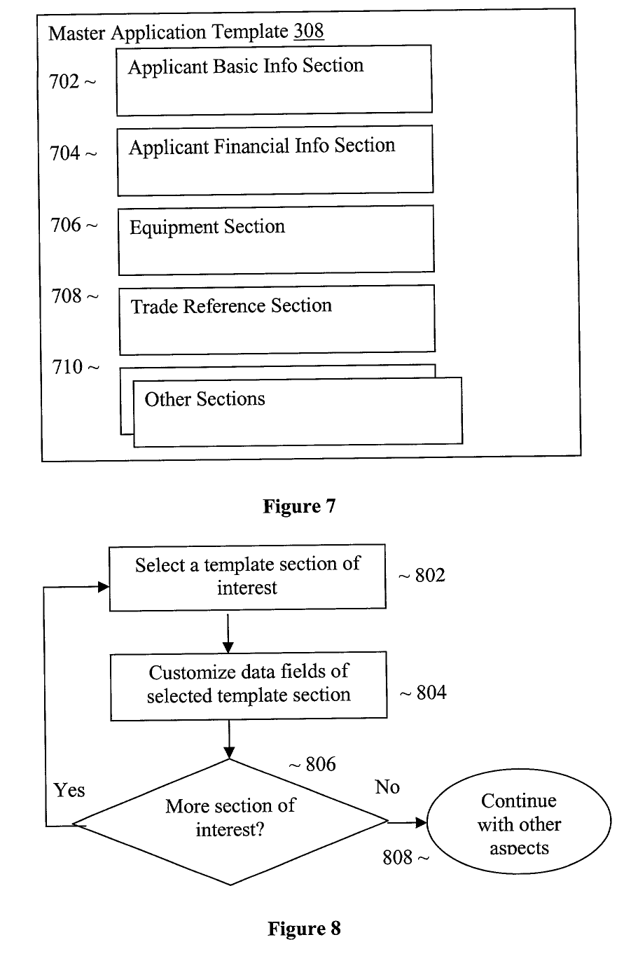

FIG. 7 illustrates a master financing application template 308, in accordance with one embodiment, and FIG. 8 illustrates a method of the present invention for creating an organization financing application template 310, in accordance with one embodiment. For the illustrated embodiment, master financing application template 308 includes a number of pre-defined sections, with each section having a number of pre-defined data fields (not shown). More specifically, section 702 includes a number of pre-defined data fields for facilitating provision of basic information about a financing applicant, section 704 includes a number of pre-defined data fields for facilitating provision of financial information about the applicant, section 706 includes a number of pre-defined data fields for facilitating provision of basic information about the equipment whose “purchase” is being financed, section 708 includes a number of pre-defined data fields for facilitating provision of trade reference information about the applicant, and possibly other sections 710.

As those skilled in the art would appreciate, for alternate embodiments, the present invention may be practiced with master financing application template 308 having more or less sections. In one embodiment, master financing application template 308 is encoded using XML. In alternate embodiments, other languages may be employed instead.

Organizational financing application template 310 is created using master financing application template 308, selectively including the available template sections, i.e. sections 702-710 (blocks 802 and 806). Depending on the general anticipated needs of the particular funding source/provider, some available template sections of master financing application template 308 may be “skipped”, i.e. not selected, while other custom sections may be added. For example, if a particular funding source/provider does not anticipate ever creating a financing program offering that would require its applicant to supply trade references, trade reference template section 708 may be “skipped” in the formation of organization financing application template 310. On the other hand, if the particular funding source/provider anticipates a special need that will be present in many financing programs, a custom section to address the special need may be included (block 808). Further, for the selected sections, depending also on the general anticipated needs of the particular funding source/provider, some pre-defined data fields of the selected template sections may also be “skipped”, i.e. not selected, while other “custom” data fields may be added (block 804).

Accordingly, a resultant organization financing application template 310 bears substantial resemblance to master financing application template 308 illustrated in FIG. 7. In one embodiment, organization financing application templates 310 are also encoded using XML. Similarly, in alternate embodiments, other languages may be employed instead.

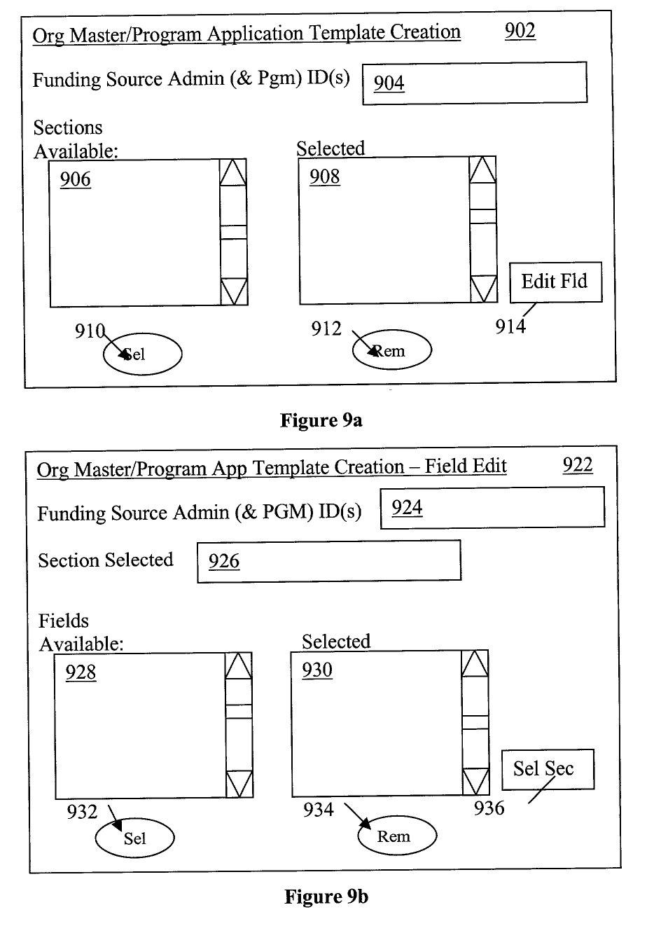

Referring now to FIGS. 9a-9b, wherein a simplified view of an end user interface of financing programs creation tool 306, in accordance with one embodiment, is shown. For the illustrated embodiment, the illustrated interface is employed for the creation of organization financing application template 310 as well as for the subsequent creation of financing program offerings 138 (to be described more fully below). Obviously, in alternate embodiments, separate interfaces may be employed instead.

As illustrated, the end user interface includes at least two panes, pane 902 for a funding source/provider to select template sections of interest to create the organizational financing program template 310 or financing programs 138, and pane 922 for a funding source/provider to select/unselect certain pre-defined fields of the selected template sections.

For the illustrated embodiment, pane 902 includes field 904 for displaying an identifier of the funding source administrator (or an identifier of the financing program offering 138 being created). Pane 902 also includes display areas 906 and 908 for displaying a list of the template sections available to the funding source/provider for selection, and for displaying the template sections the funding source/provider has selected, respectively. Further, pane 902 includes “buttons” 910 and 912 for the funding source/provider to select a highlighted template section in the displayed available list, and to remove a highlighted template section in the displayed selected list, respectively. Pane 902 also includes “buttons” 914 for “transitioning” to pane 922 to edit/customize the data fields of a highlighted template section in the selected list.

As to pane 922, for the illustrated embodiment, pane 922 includes fields 924 and 926 for displaying an identifier of an administrator of the funding source/provider (or a financing program identifier) and an identifier of the template section selected, respectively. Pane 922 also includes display areas 928 and 930 for displaying a list of the template sections available for selection, and for displaying the selected template sections, respectively. Pane 922 also includes “buttons” 932 and 934 for the administrator to select a highlighted template section in the displayed available list, and to remove a highlighted template section in the displayed selected list, respectively. Further, pane 922 also includes “button” 936 for transitioning back to pane 902 to select template sections.

As those skilled in the art would appreciate, panes 902 and 922 are also simplified to illustrate the most relevant features for ease of understanding. In actual implementations, other well known graphical user interface features may also be added.

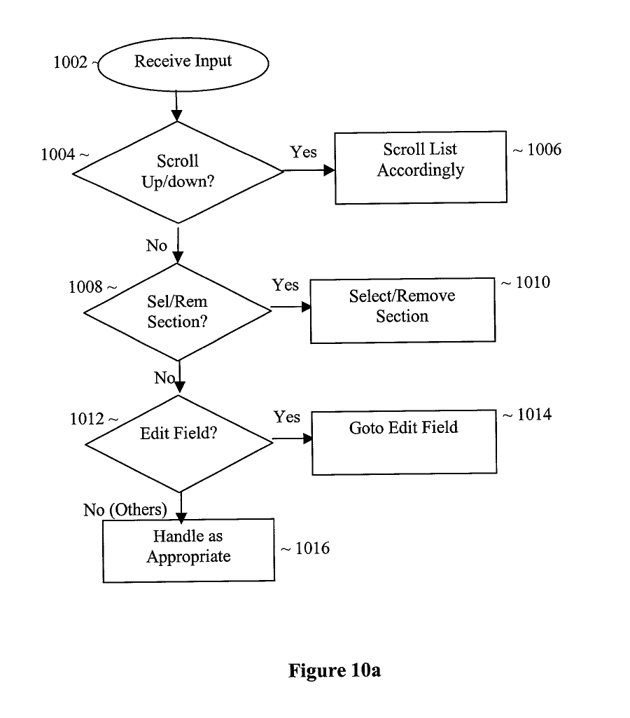

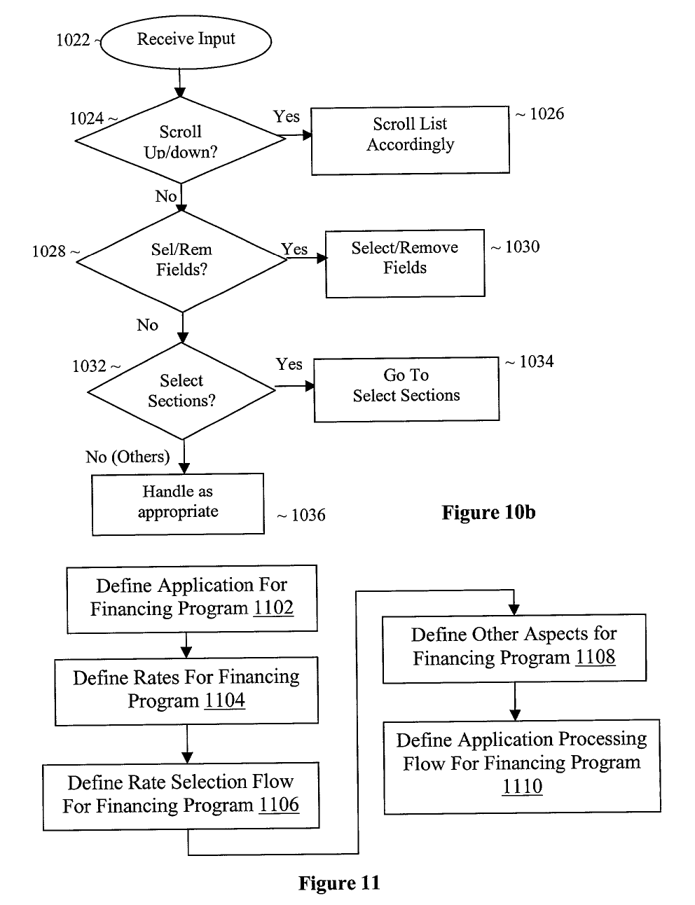

FIGS. 10a-10b illustrate the relevant operational flow of financing program creation tool 306 in support of the end user interface of FIGS. 9a-9b. As illustrated, the operational flow of financing program creation tool 306 for supporting the end user interface of FIGS. 9a-9bb are substantially the same as the earlier described operational flow of FP administration tool 302 for supporting the end user interface of FIG. 4. One major difference being at block 1012 of FIG. 10a and block 1032 of FIG. 10b, financing program creation tool 306 determines if the “edit” button of pane 902 of FIG. 9a or the “select section” button of pane 904 has been selected, respectively. If so, financing program creation tool 306 makes the corresponding transition to the other pane accordingly, as earlier described, block 1014 or 1034.

### Financing Program Offering Creation

FIG. 11 illustrates a method of the present invention for creating financing program offering 138, in accordance with one embodiment. As illustrated, the process starts at block 1102 with the definition of the application to be completed by each applicant. The major operations involved are substantially the same as those earlier described in association with the creation of organizational financing application template 310.

Thereafter, the process includes the definition of rate structures, block 1104, and the definition of a rate structure selection process, block 1106. As described earlier, definition of rate structures may be made optionally, if rate structures may be shared among program offerings.

Additionally, the process also includes the definition of other aspects of the program offering. For example, the policies of the program offering and other collateral information. The operations involved in block 1108 are application dependent and non-essential to the practice of the present invention.

For the illustrated embodiment, the process also additionally includes the definition of the financing application approval/disposition process, block 1110.

These various aspects, i.e. defining rate structures, its selection process, and the application approval/disposition process will be described in turn below.

In various embodiments, the end user interface and the process for a broker/vendor 106 to create a derivate financing program offering is substantially the same as a funding source/provider creating a financing program offering. Accordingly, the interface and the process will not be re-described

### Rate Structure Definition

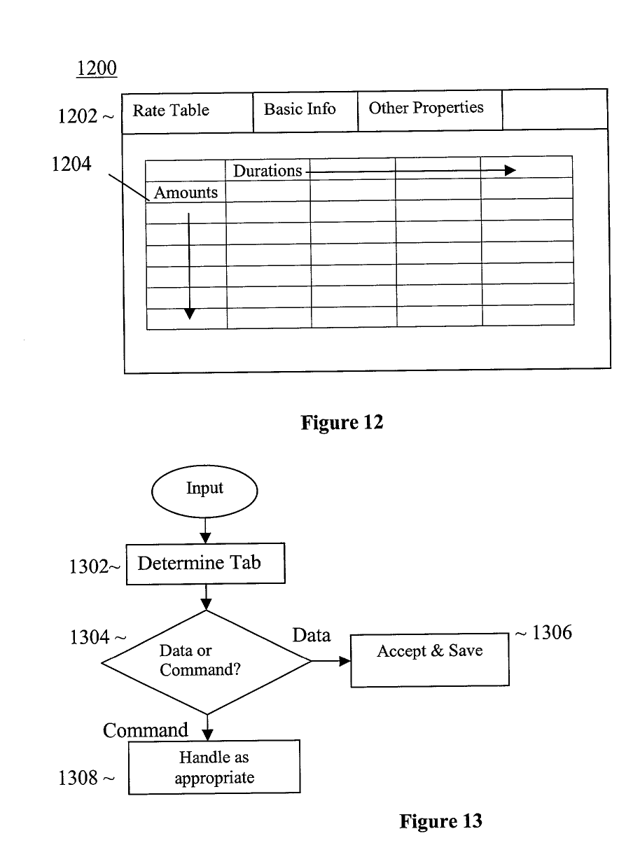

FIG. 12 illustrates a simplified end user interface suitable for use to define a rate structure to practice the present invention, in accordance with one embodiment. As illustrated, end user interface 1200 includes a number of “tabs” 1202 for facilitating entry of various information about the rate structure being defined. In particular, “tabs” 1202 includes in particular a rate table tab 1204 for facilitating entry of rates for different combination of financing amount and financing terms.

As with the earlier described end user interface, interface 1200 is purposely simplified to illustrate the essential features for ease of understanding. In actual implementations, various other graphical end user interface features known in the art may also be included.

FIG. 13 illustrates the relevant operational flow of financial program creation tool 306 in support of end user interface 1200 of FIG. 12, in accordance with one embodiment. As illustrated, the process includes determination of the current tab the user is working with, block 1302. Upon so determining, the process further includes determination of whether an input/action received from the user is a command or data to accepted and saved. If it is the later, the data is accepted and saved into the appropriate field accordingly, block 1306. On the other hand, if it is the former, the command is handled in an application dependent manner accordingly.

### Rate Selection and Financing Application Disposition Processing Definition

As described earlier, for the illustrated embodiment, both the rate selection process and the application approval/disposition process are defined as workflows (hereinafter also referred to as workflow process or processes). The workflow processes are executed when an application is being completed and/or being processed. Rate selection process is executed when an application is completed if an application is being completed for presentation as a quote to a client of a broker/vendor. Otherwise, both processes are executed when the application is processed for approval or disapproval disposition.

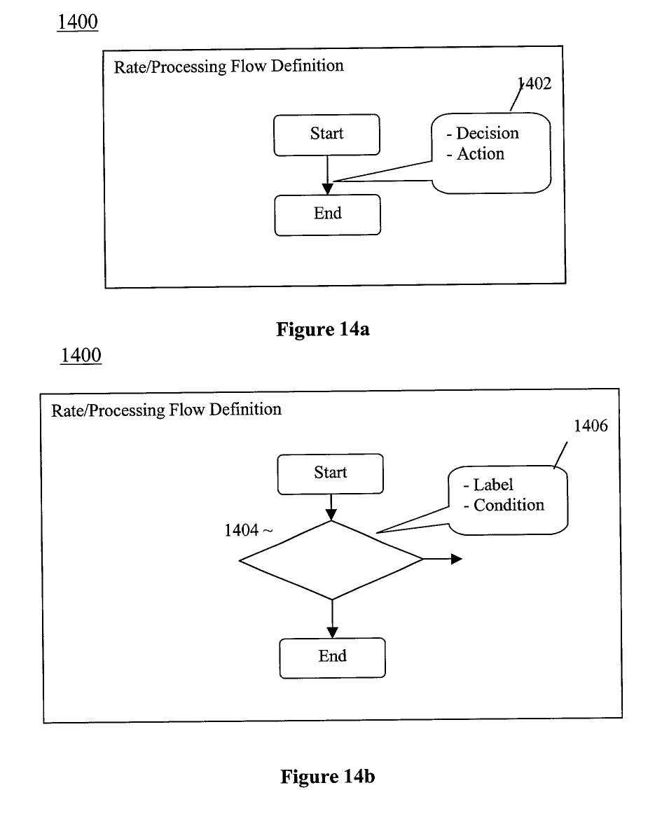

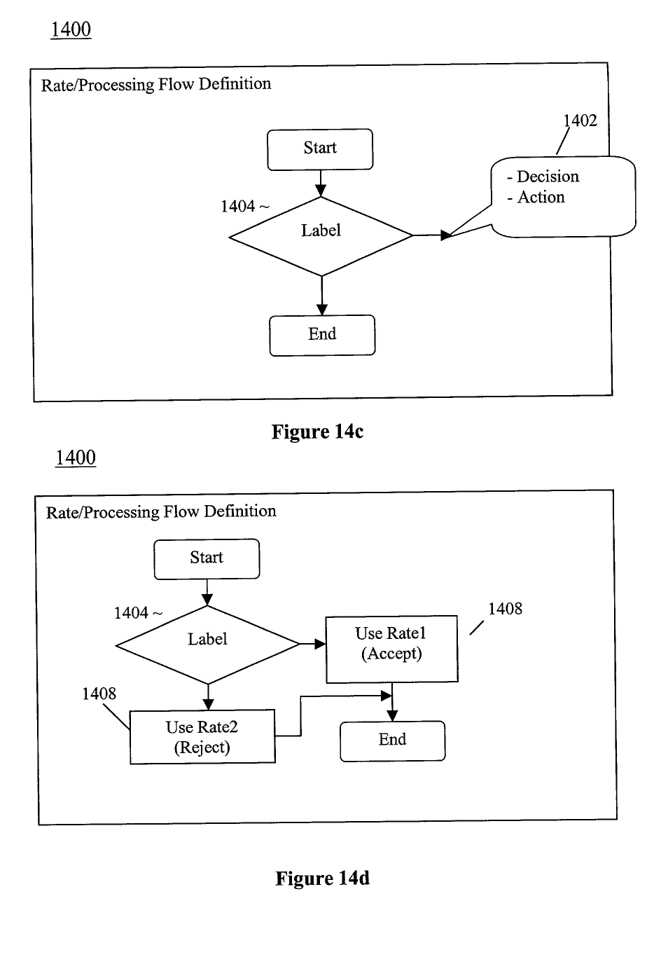

FIGS. 14a-14b illustrate a simplified end user interface 1400 suitable for facilitating a user in defining a rate selection or an application approval/disposition process, in accordance with one embodiment. As illustrated in FIG. 14a, initially, the user is presented with a skeleton flow diagram having only the “start” and the “end” block. At the request of a user, the user is offered a choice to proceed with the definition of a decision or an action. The request may be communicated in any one of a number of techniques known in the art, e.g. by way of the right click of a mouse, or entry of a predetermined key sequence, such as “ctrl-l”.

Assuming the user has selected to proceed to define a decision, as illustrated in FIG. 14b, decision block 1404 is inserted into the flow diagram. Again, at the request of the user, the user is offered a choice to proceed with the entry of a label for the decision icon or entry of the “test condition” to be associated with the decision being defined. Again, the request may be communicated in any one of a number of techniques known in the art.

Assuming the user has entered the label and the “test condition” to be associated with the decision, as illustrated in FIG. 14c, decision block 1404 is labeled accordingly, and the “test condition” is saved. Once again, at the request of the user, the user is offered a choice to define a decision or an action.

Assuming the user has elected to define an action for each of “true” and “false” condition of the “test condition” associated with decision block 1404, the decision flow diagram is updated accordingly with the actions to be taken under the respective conditions, as illustrated in FIG. 14d.

Thus, by repeatedly defining decision blocks for the “true” and “false” conditions of “predecessor” decision blocks, a complex multi-level decision process (for either rate selection or application approval/disposition processing) may be defined.

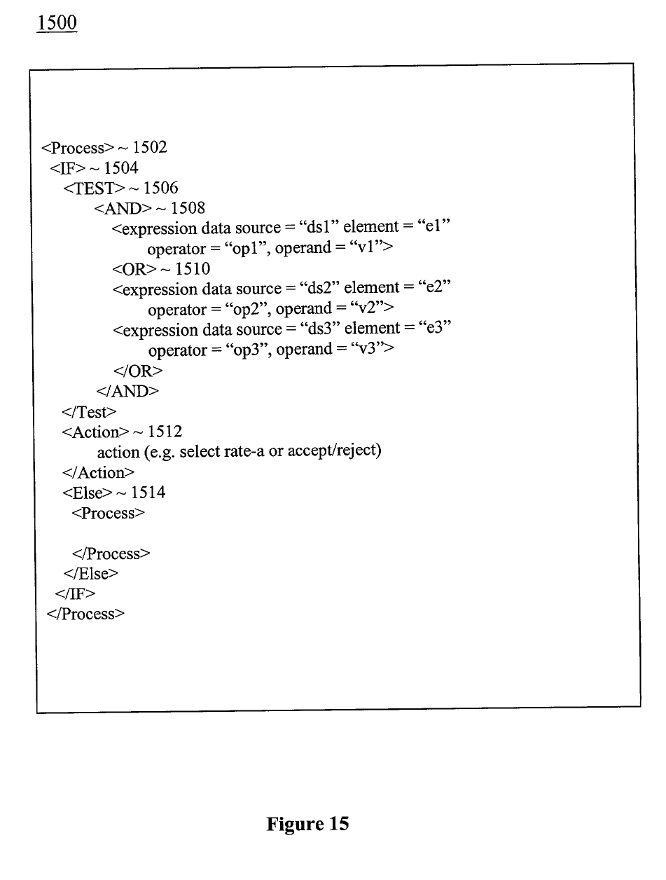

As described earlier, in one embodiment, the workflow process defined is represented employing an XML like representation having XML like statements. FIG. 15 illustrates an example one of such XML like representation, employing XML like statements. As illustrated, the workflow process is delineated by a pair of <process>, </process> tags 1502. Within each process, an if-then-else structure is delineated through the employment of <if> and </if> tags 1504, and <else> and </else> tags 1506. The test condition for the “if” section is delineated by the <test> and </test> tags 1508. The various expression segments of a test condition is joined together through the employment of <and>and </and>tags 1508 and <or>and </or>tags 1510. Each expression includes the syntactical convention of specifying the data source particularized to a data element granularity, the operator and the operand (i.e. certain constant value or another data element) to be employed. Accordingly, a workflow representation may be represented.

Note that a process may contain one or more nested processes. Further, in alternate embodiments, other tags may be employed to further extend the representative capability of XML like representation 1500.

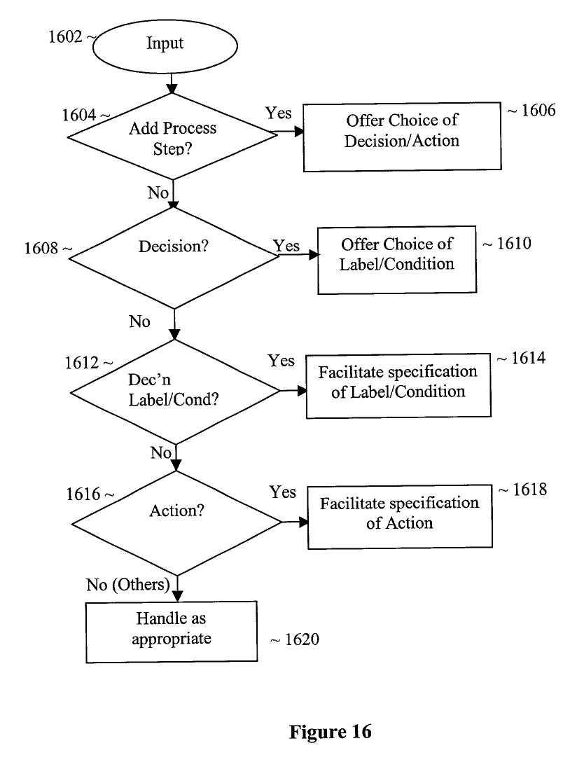

FIG. 16 illustrates the relevant operational flow of program offering creation tool 306 in support of definition of a workflow process, in accordance with one embodiment. As illustrated, upon receipt of a user input, block 1602, tool 306 determines if the input is a request to add a process step to the workflow process, block 1604. If so, as described earlier, tool 306 offers the user a choice of adding a decision block or an action block, block 1606.

If the request is not to add a process step, tool 306 determines if the request to add a decision block, block 1608. If so, as described earlier, tool 306 offers the user a choice of adding the label for the decision block or specifying the test condition for the decision block, block 1610.

If the request is not to add a decision block, tool 306 determines if the request is to enter a label or define a test condition for a decision block, block 1612. If so, as described earlier, tool 306 facilitates their entry or definition accordingly, block 1614.

If the request is not to enter a label or define a test condition for a decision block, tool 306 determines if the request is to define an action, block 1616. If so, as described earlier, tool 306 facilitates their definition of the action accordingly, block 1618.

If the request is not for definition of an action, it is assumed to be other conventional request, and the request is handled conventionally in an application dependent manner.

### Completing Financing Application

As described earlier, a broker/vendor may complete an application for itself, or on behalf of a client for consideration under an authorized program offering of a funding source/provider, or alternatively may facilitate a client in completing and submitting such an application for consideration directly. A vendor/broker may perform the facilitation for example by “branding” the services offered by FAS provider 102 (i.e. presenting a “branded” front end with the functionalities being transparently provided by FAS provider 102).

In one embodiment, completed applications 148 are also encoded using XML, and stored as XML documents. Similarly, in alternate embodiments, other languages may be employed instead. Further, in yet other embodiments, the data may be extracted and stord in a database instead.

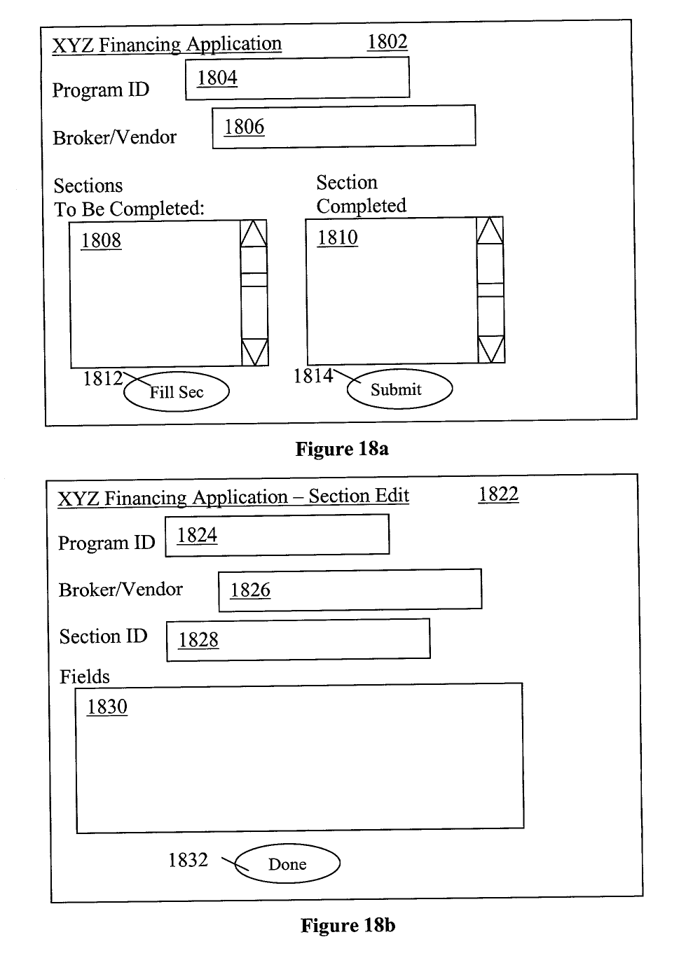

Regardless of the manner of completion, FIGS. 18a-18b illustrate a simplified end user interface suitable for facilitating a user in completing a financing application under a program offering created in a manner as earlier described, in accordance with one embodiment. As illustrated in FIG. 18a, the end user interface includes at least two panes, pane 1802 for a user to select a section of the application to complete, and pane 1822 for completing the selected section.

For the illustrated embodiment, pane 1802 includes fields 1804 and 1806 for displaying an identifier of the program offering and an identifier of the broker/vendor, respectively. Pane 1802 also includes display areas 1808 and 1810 for displaying a list of the sections remaining to be completed, and for displaying the completed sections, respectively. Further, pane 1802 includes “buttons” 1812 and 1814 for transitioning to pane 1822 to complete a highlighted incomplete section in the displayed incomplete section list, and to submit the completed application, respectively.

As to pane 1822, for the illustrated embodiment, pane 1822 similarly includes fields 1824 and 1826 for displaying an identifier of the program offering and an identifier of the broker/vendor, respectively. Pane 1822 also includes field 1828 for displaying the selected section identifier, and field 1830 of the selected section to be completed. Further, pane 1822 includes “button” 1832 for transitioning back to pane 902 to select another section to complete (when the current selected section has been completed).

As those skilled in the art would appreciate, panes 1802 and 1822 are also simplified to illustrate the most relevant features for ease of understanding. In actual implementations, other well known graphical user interface features may also be added. Further, various data accuracy and completeness checking known in the art may also be included.

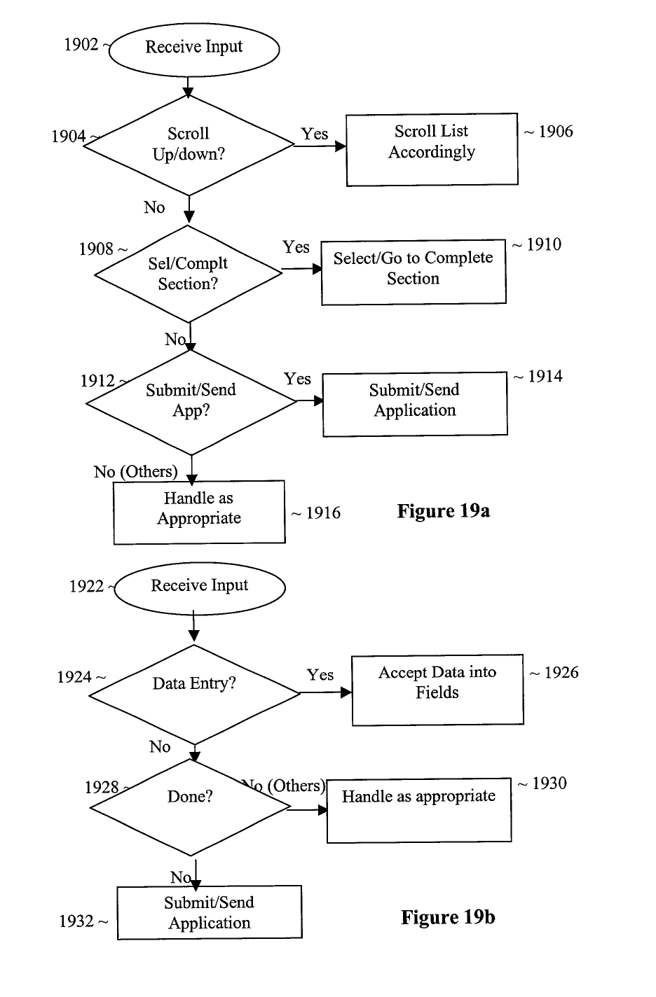

FIGS. 19a-19b illustrate the relevant operational flow of financing application module 312 in support of the end user interface of FIG. 18a-18b, in accordance with one embodiment. As illustrated, the operational flow of financing application module 312 for supporting the end user interface of FIGS. 18a-18b are substantially the same as the earlier described operational flow of FP administration tool 302 for supporting the end user interface of FIG. 4. One major difference is the operation performed at block 1912 of FIG. 19a and block 1928 of FIG. 19b respectively. At block 1912 of FIG. 19a, financing application module 312 determines if the “submit” button of pane 1802 of FIG. 18a has been selected. At block 1928 of FIG. 19b, financing application module 312 determines if the “done” button of pane 1822 has been selected. If so (in each case), financing application module 312 makes the corresponding transition to the other pane accordingly, as earlier described, block 1912 or 1928.

### Workflow Execution

As described earlier, for the illustrated embodiment, the rate selection workflow is executed either at application completion time when a broker/vendor completes a financing application for presentation to a client as a quote, or at application processing time for a financing application submitted by a client. Further, the application approval/disposal workflow is executed when a completed application is processed.

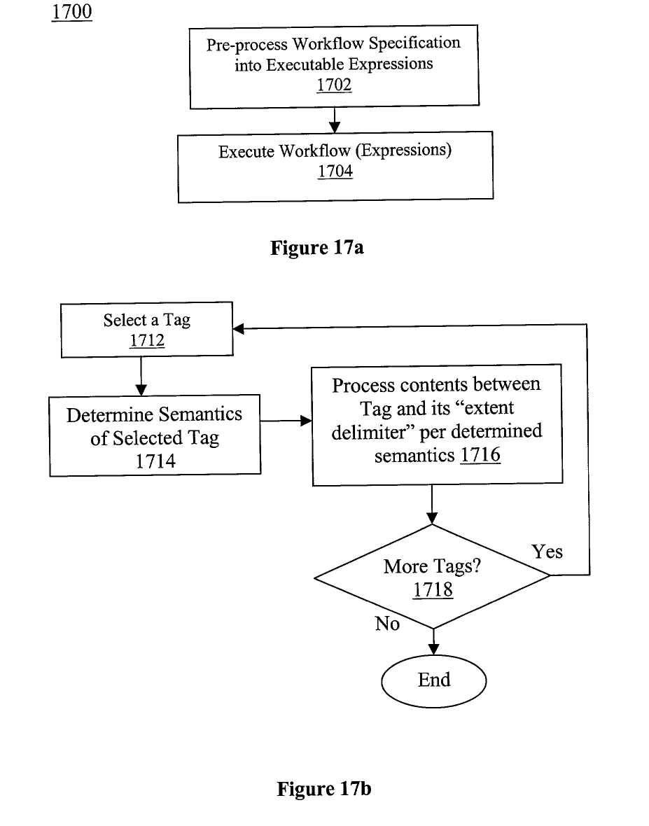

FIGS. 17a-17b illustrate the relevant operational flow of workflow processing module 314 for executing workflows, in accordance with one embodiment. For the illustrated embodiment, a workflow is assumed to be expressed by way of a representation similar to the representation of FIG. 15. Thus, as illustrated in FIG. 17a, at block 1702, module 314 first pre-processes the workflow specification or representation, converting the specifications back into executable expressions. Thereafter, the executable statements are executed, block 1704.

As illustrated in FIG. 17b, the process for generating executable expression in accordance with the specified workflow statements start at block 1712, wherein a tag is read (in accordance with their order of specification). The meaning of the tag is “determined”, e.g. by referencing a “schema” or a “semantic table”, or transferring processing to a code segment designed to handle the particular tag type, block 1714. At block 1716, the content between the tag and its complementary delimiter tag (such as <and>and </and>) is processed, and executable code are generated accordingly. Code generation for known semantic is known in the compiler art, accordingly will not be further described. The operations of block 1712-1716 are repeated recursively, to recursively process the contents with additional tag pairs present in between a tag pair.

Upon processing the content between a tag pair (recursively if necessary), module 314 determines at block 1718, whether additional specifications remain to be processed. If so, the process returns back to block 1722, otherwise the process terminates.

### Example System Architectures

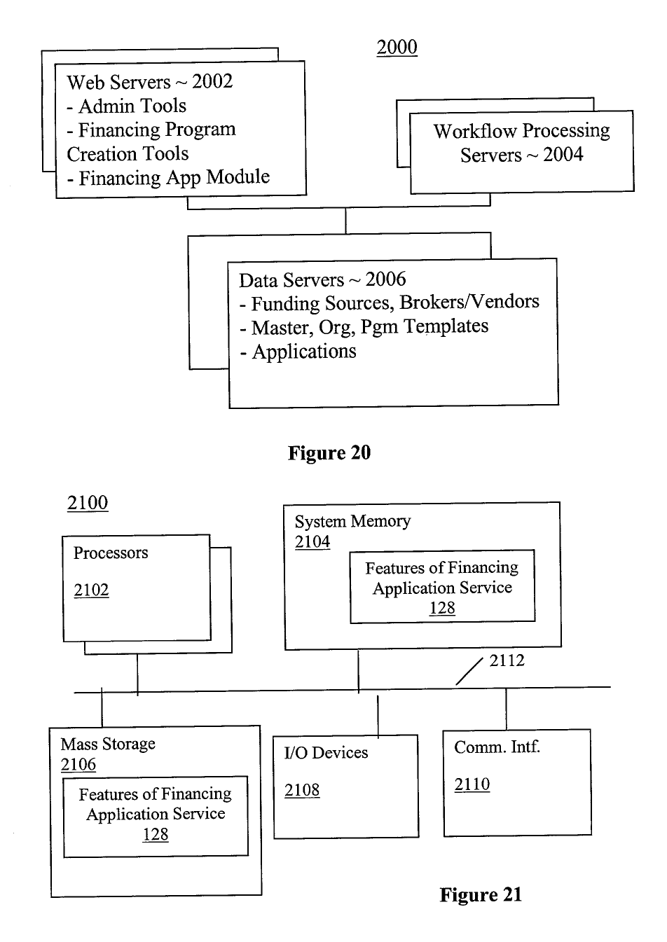

FIG. 20 illustrates a network environment suitable for practicing the present invention. As illustrated, network environment 2000 includes web servers 2002, workflow processing servers 2004, and data servers 2006. The various servers are coupled to each other through private networking fabric, whereas web servers 2002 are coupled to the funding sources/providers and brokers/vendors via private and/or public networks, employing known networking technologies.

Web servers 2002 is employed to host the earlier described administration tool 302, program creation tools 306 and financing application modules 308, implemented as web based applications, employing dynamic web page generation and associated client applets as well as server executed scripts. These various underlying technologies are known in the art, accordingly will not be further described.

Workflow processing servers 2004 are employed to host the earlier described workflow processing module 314. Module 314 may be implemented in any one of a number of system programming languages, such as C or C++.

Data servers 2006 are employed to store the data associated with the funding sources/providers and brokers/vendors, the organizational application templates, the created program offerings and the completed applications, and facilitate their retrieval when needed. An example of a suitable data server technology includes but is not limited to relational database servers.

Servers 2002-2006 are intended to represent a broad range of computer servers known in the art, including general purpose as well as special purpose computers of all form factors, from desk top to rack mounted. An example computer suitable for use is illustrated in FIG. 21. As illustrated, example computer system 2100 includes one or more processors 2102 (depending on whether computer system 2100 is used as server computer 2002, 2004 or 2006), and system memory 2104 coupled to each other via “bus” 2112. Coupled also to “bus” 2112 are nonvolatile mass storage 2106, input/output (I/O) devices 2108 and communication interface 2114. During operation, memory 2104 includes working copies of programming instructions implementing teachings of the present invention.

Except for the teachings of the present invention incorporated, each of these elements is intended to represent a wide range of these devices known in the art, and perform its conventional functions. For example, processor 2102 may be a processor of the Pentium® family available from Intel Corporation of Santa Clara, Calif., or a processor of the PowerPC® family available from IBM of Armonk, N.Y. Processor 2102 performs its conventional function of executing programming instructions, including those implementing the teachings of the present invention. System memory 2104 may be SDRAM, DRAM and the like, from semiconductor manufacturers such as Micron Technology of Boise, Id. Bus 2112 may be a single bus or a multiple bus implementation. In other words, bus 2112 may include multiple buses of identical or different kinds properly bridged, such as Local Bus, VESA, ISA, EISA, PCI and the like.

Mass storage 2106 may be disk drives or CDROMs from manufacturers such as Seagate Technology of Santa Cruz of Calif., and the like. Typically, mass storage 2106 includes the permanent copy of the applicable portions of the programming instructions implementing the various teachings of the present invention. The permanent copy may be installed in the factory, or in the field, through download or distribution medium. I/O devices 2108 may include monitors of any types from manufacturers such as Viewsonic of City, State, and cursor control devices, such as a mouse, a track ball and the like, from manufacturers such as Logitech of Milpitas, Calif. Communication interface 2110 may be a modem interface, an ISDN adapter, a DSL interface, an Ethernet or Token ring network interface and the like, from manufacturers such as 3COM of San Jose, Calif.

### Conclusion and Epilog

Thus, methods and apparatuses for providing on-line financing application services have been described. While the present invention has been described in terms of the above illustrated embodiments, those skilled in the art will recognize that the invention is not limited to the embodiments described. The present invention can be practiced with modification and alteration within the spirit and scope of the appended claims. The description is thus to be regarded as illustrative instead of restrictive on the present invention.

What is claimed is:

1. In an electronic application service apparatus, a method of operation comprising:
electronically facilitating completion by a user a financing application under an electronically accessible financing program offering of a funding source; and
in response, automatically selecting a rate structure for the financing application in accordance with a pre-defined rate structure selection process of the electronically accessible financing program offering.

2. The method of claim 1, wherein said user is a selected one of a broker/vendor completing the financing application on behalf of a client of the broker/vendor and the client of the broker/vendor.

3. The method of claim 1, wherein said automatic selection of a rate structure is further performed based on selected information provided in said one or more sections of said financing application.

4. The method of claim 1, wherein said rate selection process comprises at least a first decision and a first plurality of actions.

5. The method of claim 4, wherein at least one of said first plurality of actions is a second decision.

6. The method of claim 1, wherein said rate structure selection process is expressed in an XML-like representation, and said automatic selection of a rate structure for the financing application comprises automatically generating one or more expressions in accordance with XML-like statements of the XML-like representation, and executing the generated one or more expressions.

7. The method of claim 1, wherein the method further comprises:
electronically facilitating submission of the completed financing application for consideration under the financing program offering; and
automatically processing the submitted financing application in accordance with a pre-defined financing application approval/disposition process of the financing program offering, and determining whether the financing application is to be approved.

8. The method of claim 7, wherein said determining further comprises whether determining whether the financing application is to be rejected or referred, if it is determined that the financing is not to be approved.

9. The method of claim 7, wherein said automatic processing of the submitted financing application is further performed based on selected information provided in said one or more sections of said financing application.

10. The method of claim 7, wherein said financing application approval/disposition process comprises at least a first decision and a first plurality of actions.

11. The method of claim 10, wherein at least one of said first plurality of actions is a second decision.

12. The method of claim 1, wherein said application approval/disposition process is expressed in an XML-like representation, and said automatic processing of the financing application comprises automatically generating one or more expressions in accordance with XML-like statements of the XML-like representation, and executing the generated one or more expressions.

13. In an electronic application service apparatus, a method of operation comprising:
electronically receiving a financing application submitted for consideration under an electronically accessible financing program offering; and
electronically processing the financing application to determine a disposition in accordance with an application approval/disposition process of the electronically accessible financing program offering.

14. The method of claim 13, wherein said determining further comprises whether determining whether the financing application is to be rejected or referred, if it is determined that the financing is not to be approved.

15. The method of claim 13, wherein said automatic processing of the submitted financing application is further performed based on selected information provided in said one or more sections of said financing application.

16. The method of claim 13, wherein said financing application approval/disposition process comprises at least a first decision and a first plurality of actions.

17. The method of claim 16, wherein at least one of said first plurality of actions is a second decision.

18. The method of claim 13, wherein said application approval/disposition process is expressed in an XML-like representation, and said automatic processing of the financing application comprises automatically generating one or more expressions in accordance with XML-like statements of the XML-like representation, and executing the generated one or more expressions.

19. An apparatus comprising:
a storage medium having stored therein a plurality of programming instructions, when executed, operate the apparatus to
electronically facilitate completion by a user a financing application under an electronically accessible financing program offering of a funding source, and
to automatically select, in response, a rate structure for the financing application in accordance with a pre-defined rate structure selection process of the electronically accessible financing program offering; and
one or more processors coupled to the storage medium to execute the programming instructions.

20. The apparatus of claim 19, wherein said user is a selected one of a broker/vendor completing the financing application on behalf of a client of the broker/vendor and the client of the broker/vendor.

21. The apparatus of claim 19, wherein said programming instructions, when executed, operate the apparatus to further base said performance of said automatic selection of a rate structure on selected information provided in said one or more sections of said financing application.

22. The apparatus of claim 19, wherein said rate selection process comprises at least a first decision and a first plurality of actions.

23. The apparatus of claim 22, wherein at least one of said first plurality of actions is a second decision.

24. The apparatus of claim 19, wherein said rate structure selection process is expressed in an XML-like representation, and said programming instructions, when executed, operate the apparatus to perform said automatic selection of a rate structure for the financing application by automatically generating one or more expressions in accordance with XML-like statements of the XML-like representation, and executing the generated one or more expressions.

25. The apparatus of claim 19, wherein the programming instructions, when executed, further operate the apparatus to
electronically facilitate submission of the completed financing application for consideration under the financing program offering; and
automatically process the submitted financing application in accordance with a pre-defined financing application approval/disposition process of the financing program offering, and determining whether the financing application is to be approved.

26. The apparatus of claim 25, wherein said programming instructions, when executed, further operate the apparatus to further determine whether the financing application is to be rejected or referred, if it is determined that the financing is not to be approved.

27. The apparatus of claim 25, wherein said programming instructions, when executed, further operate the apparatus to further base said automatic processing of the submitted financing application on selected information provided in said one or more sections of said financing application.

28. The apparatus of claim 25, wherein said financing application approval/disposition process comprises at least a first decision and a first plurality of actions.

29. The apparatus of claim 28, wherein at least one of said first plurality of actions is a second decision.

30. The apparatus of claim 19, wherein said application approval/disposition process is expressed in an XML-like representation, and said programming instructions, when executed, further operate the apparatus to perform said automatic processing of the financing application by automatically generating one or more expressions in accordance with XML-like statements of the XML-like representation, and executing the generated one or more expressions.

31. An apparatus comprising:
a storage medium having stored therein a plurality of programming instructions, when executed, operate the apparatus to
electronically receive a financing application submitted for consideration under an electronically accessible financing program offering, and
electronically process the financing application to determine a disposition in accordance with an application approval/disposition process of the electronically accessible financing program offering; and
one or more processors coupled to the storage medium to execute the programming instructions.

32. The apparatus of claim 31, wherein said programming instructions, when executed, further operate the apparatus to determine whether the financing application is to be rejected or referred, if it is determined that the financing is not to be approved.

33. The apparatus of claim 31, wherein said programming instructions, when executed, further operate the apparatus to base said automatic processing of the submitted financing application on selected information provided in said one or more sections of said financing application.

34. The apparatus of claim 31, wherein said financing application approval/disposition process comprises at least a first decision and a first plurality of actions.

35. The apparatus of claim 34, wherein at least one of said first plurality of actions is a second decision.

36. The apparatus of claim 31, wherein said application approval/disposition process is expressed in an XML-like representation, and said programming instructions, when executed, further operate the apparatus to perform said automatic processing of the financing application by automatically generating one or more expressions in accordance with XML-like statements of the XML-like representation, and executing the generated one or more expressions.
